(19) United States
(12) Patent Application Publication
(10) Pub. No.: US 2017/0310673 A1
(43) Pub. Date: Oct. 26, 2017

(54) SECURITY SYSTEM WITH GESTURE-BASED ACCESS CONTROL

(71) Applicant: Huami Inc., Mountain View, CA (US)

(72) Inventors: Xiao-feng Li, Mountain View, CA (US); Jun Yang, Mountain View, CA (US)

(21) Appl. No.: 15/133,687

(22) Filed: Apr. 20, 2016

(51) Int. Cl. H04L 29/06

(52) U.S. Cl. CPC H04L 63/10; H04L 63/08

(57) ABSTRACT

A method for gesture-based access control of a secured target using a mobile device, such as a wristband or smart phone, is disclosed. The method includes receiving worn signal data indicative of possession of the mobile device by a user from a sensor of the mobile device, receiving gesture signal data indicative of at least one gesture performed by the user, and based on the worn signal data indicating possession of the mobile device and the at least one gesture matching a gesture template, generating security access signal data configured to provide access to the secured target.

### TECHNICAL FIELD

This disclosure relates to a use of a mobile device, for example, a wearable device, in a tiered management scheme for a security system including gesture-based access to a secured target.

### BACKGROUND

Mobile devices and wearable devices, such as smartphones, wristbands, watches, headsets, glasses, and tablets, are becoming increasingly commonplace tools used to interleave computing technology into daily life. These devices can be used in a variety of contexts, such as to monitor the health of a user by measuring vital signals, track a user's exercise and fitness progress, check a user's emails or social media accounts, etc. As mobile technology becomes more prevalent, so does the need for improved security processes implemented using mobile technology.

Though mobile devices and wearable devices can be configured to interact with nearby devices or objects using, for example, Bluetooth or similar wireless communications technology, many of these devices are limited in capability, having restricted sensing, input, output, or data transfer capabilities that are not suited to replace more traditional security features such as the entry of a password or a password-like screen pattern or the capture of a fingerprint, voice-pattern, facial feature, or electrocardiogram (ECG) signature.

### SUMMARY

Disclosed herein is a method for gesture-based access control of a secured target using a mobile device. The method includes receiving, from a sensor of the mobile device, worn signal data indicative of possession of the mobile device by a user; receiving, from the sensor of the mobile device, gesture signal data indicative of at least one gesture performed by the user; and based on the worn signal data indicating possession of the mobile device and the at least one gesture matching a gesture template, generating security access signal data configured to provide access to the secured target.

Also disclosed herein is a wearable device for gesture-based access control of a secured target. The wearable device includes a body configured to be coupled to a portion of a user; a sensor comprising an infrared sensor and an accelerometer; a communication component configured to communicate signal data generated by the sensor to a computing device; and a memory and a processor configured to execute instructions stored in the memory to: receive worn signal data from the infrared sensor indicative of the wearable device being worn by the user; receive gesture signal data from the accelerometer indicative of at least one gesture performed by the user; and based on the worn signal data indicating the wearable device is worn by the user and the at least one gesture matching a gesture template, generate security access signal data configured to provide access to the secured target.

Also disclosed herein is a system for gesture-based access control of a secured target. The system includes a wearable device comprising a sensor and a communication component and a mobile device in communication with the communication component. The mobile device comprises a memory and a processor configured to execute instructions stored in the memory to: receive, from the sensor through the communication component, worn signal data indicative of the wearable device being worn by a user; receive, from the sensor through the communication component, gesture signal data indicative of at least one gesture performed by the user; and based on the worn signal data indicating the wearable device is worn by the user and the at least one gesture matching a gesture template, generate security access signal data configured to provide access to the secured target.

Details of these implementations, modifications of these implementations, and additional implementations are described below.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIGS. 1A and 1B are illustrations of a security system using a wearable device and a mobile device for gesture-based access control of a secured target.

FIG. 2 is a diagram of a wearable device.

FIG. 3 is a diagram of a mobile device.

FIG. 4 is a logic diagram showing an example of processing wearable device data.

FIG. 5 is a flow chart showing an example of a pre-processing signal data.

FIG. 6 is a flow chart showing an example of a method for gesture-based access control of a secured target.

FIG. 7 is a graphical illustration of infrared signal data captured by a wearable device.

FIGS. 8A-8D are graphical illustrations of acceleration signal data for user-designated gestures.

### DETAILED DESCRIPTION

Wearable devices can be leveraged in several ways to more easily integrate computer technology into daily life. For examples, wearable devices can be used to provide signal data for gesture recognition. Gesture recognition refers generally to the identification of various gestures communicated by a user. It can also refer to the ability of a user or device to respond to various gestures in some meaningful way based on how the gestures are communicated. For example, gesture recognition can be used as a security access feature with devices configured to receive data indicative of the gesture before allowing access to a secured target.

Some users may hesitate to adopt gesture-based security access controls due to factors such as embarrassment at performing complex gestures in a public forum, frustration with needing to repeat a gesture to gain recognition, or concern with other individuals observing the user's gestures and learning how the user provides access to certain secured targets. The systems and methods of the present disclosure address these factors by describing new ways to communicate and process signal data available from wearable devices for use in security systems that leverage gesture-based access control.

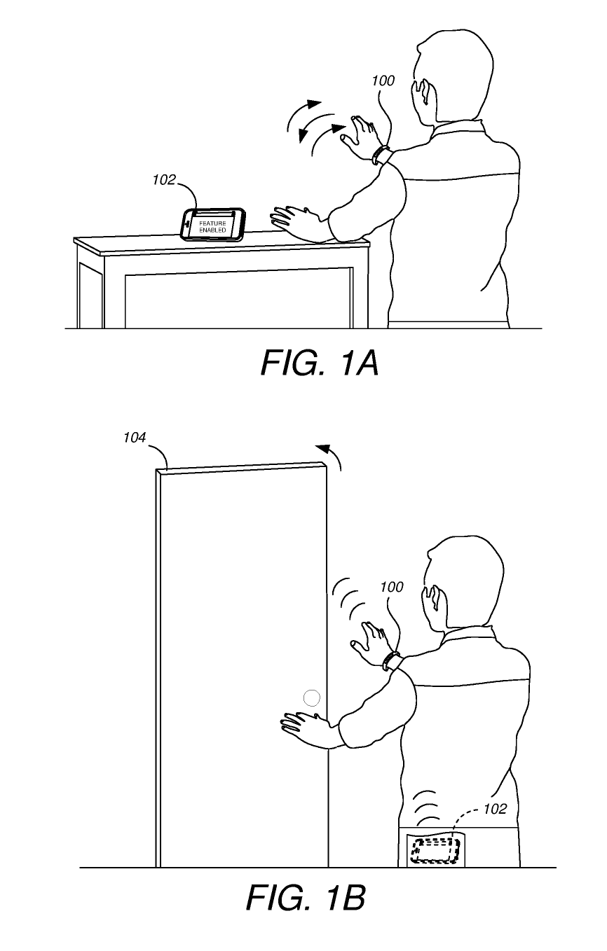

FIGS. 1A and 1B are illustrations of a security system using a wearable device 100 and a mobile device 102 for gesture-based access control of a secured target 104. The wearable device 100 can be a wristband worn around a user's wrist as shown or worn in any other identifiable manner by the user that indicates the wearable device 100 is on the person of the user. Signal data indicative of the wearable device 100 being worn by the user, i.e. worn signal data, and of the user's gestures while wearing the wearable device 100, i.e. gesture signal data, can be generated by sensors of the wearable device 100.

In one example, the worn signal data and the gesture signal data can be generated when the wearable device 100 is proximate to the mobile device 102. In another example, the worn signal data and the gesture signal data can be generated when the wearable device 100 is not proximate to the mobile device 102. In the second example, the worn signal data and the gesture signal data are stored by the wearable device 100 for later communication to the mobile device 102. The mobile device 102 can receive the worn signal data and the gesture signal data from the wearable device 100. The mobile device 102 can then determine whether the wearable device 100 is worn by the user based on the worn signal data and compare gestures made using the wearable device 100 per the gesture signal data to gesture templates associated with access control of the secured target 104.

If the wearable device 100 is worn and an identified gesture matches a gesture template, the mobile device 102 can generate security access signal data for transmission to the secured target 104. The secured target 104 can be a door associated with a restricted space as shown in FIG. 1B, a program accessible through the mobile device 102, or any other item or object able to be restricted and accessed using electronic security features. The secured target 104 can receive the security access signal data directly from the wearable device 100, from the mobile device 102, or from a combination of the wearable device 100 and the mobile device 102.

For example, while in the privacy of his home and as shown in FIG. 1A, a user can perform a personalized gesture of waving and/or rotating his hand back and forth three times (indicated by the arrows) while wearing the wearable device 100 in order to enable a security access feature associated with a locked door outside of his home, that is, the locked door is the secured target 104. In response to signal data indicating that the user is wearing the wearable device 100 and has performed the appropriate personalized gesture as matched to a gesture template, the wearable device 100 can provide an indication to the user that the security access feature associated with the secured target 104 has been enabled, for example, using haptic vibration or displaying a series of lights without the use of the mobile device 102. In other examples, the mobile device 102 can provide an indication to the user that the security feature has been enabled by indicating “feature enabled” on a display as shown in FIG. 1A.

Once the user has performed the personalized gesture, here, the hand rotating or waving back and forth three times, associated with the security access feature for the secured target 104 while wearing the wearable device 100, security access signal data can be generated, and the user can rely on proximity of the wearable device 100 and/or the mobile device 102 to gain access to the secured target 104 so long as the wearable device 100 remains worn. For example, the user can leave his home, head to work, and encounter the secured target 104 of the locked door as shown in FIG. 1B. The wearable device 100, the mobile device 102, or the combination of the two can transmit the security access signal data to the secured target 104, and the locked door can unlock and/or open (as shown by the arrow in FIG. 1B) based on the security access signal data received from the wearable device 100 and/or the mobile device 102 without further gestures or input from the user.

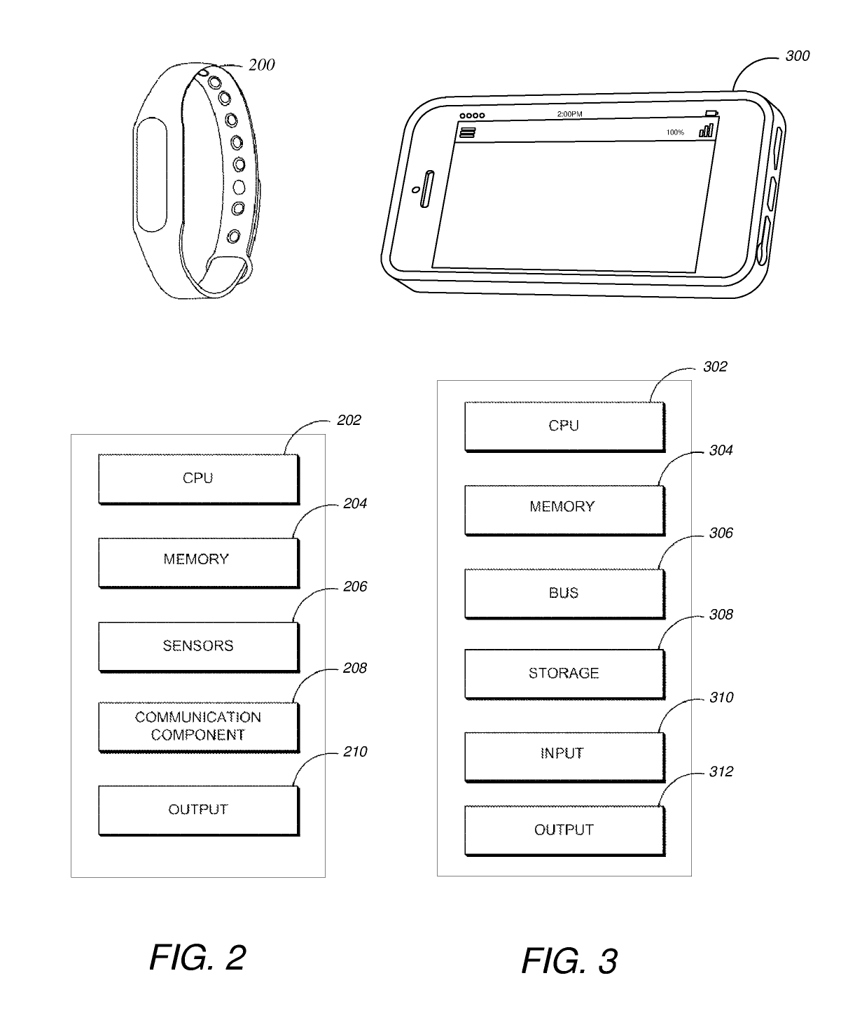

FIG. 2 is a diagram of a wearable device 200, for example, for use in the security system of FIG. 1. The wearable device 200 can be implemented in any suitable form, such as a brace, wristband, arm band, leg band, ring, headband, and the like. In one implementation, the wearable device 200 comprises a body configured to be coupled to a portion of the user. For example, the body can be a band wearable about the user's wrist, ankle, arm, leg, or any other suitable part of the user's body. Various components for operation of the wearable device 200 can be disposed within or otherwise coupled to portions of the body. In an implementation where the body of the wearable device 200 comprises a band, a securing mechanism can be included to secure the band to the user. The securing mechanism can comprise, for example, a slot and peg configuration, a snap-lock configuration, or any other suitable configuration for securing the band to the user.

In one implementation, the wearable device 200 comprises CPU 202, memory 204, sensors 206, communication component 208, and output 210. One example of the CPU 202 is a conventional central processing unit. The CPU 202 may include single or multiple processors each having single or multiple processing cores. Alternatively, the CPU 202 may include another type of device, or multiple devices, capable of manipulating or processing information now-existing or hereafter developed. Although implementations of the wearable device 200 can be practiced with a single CPU as shown, advantages in speed and efficiency may be achieved using more than one CPU.

The memory 204 in the wearable device 200 can comprise random access memory device (RAM) or any other suitable type of storage device. The memory 204 may include executable instructions and data for immediate access by the CPU 202, such as data generated and/or processed in connection with the sensors 206. The memory 204 may include one or more DRAM modules such as DDR SDRAM. Alternatively, the memory 204 may include another type of device, or multiple devices, capable of storing data for processing by the CPU 202 now-existing or hereafter developed. The CPU 202 may access and manipulate data in the memory 204 via a bus (not shown).

The sensors 206 can be one or more sensors disposed within or otherwise coupled to the wearable device 200, for example, for identifying, detecting, determining, or otherwise generating signal data indicative of measurements associated with wearable device 200 and/or the user wearing the wearable device 200. In one implementation, the sensors 206 can comprise one or more EMG sensors, accelerometers, cameras, infrared sensors, touch sensors, and the like. The accelerometers can be three-axis, six-axis, nine-axis, or any other suitable accelerometers. The cameras can be RGB cameras, infrared cameras, monochromatic infrared cameras, or any other suitable cameras. The lights can be infrared light emitting diodes (LED), infrared lasers, or any other suitable lights. Implementations of the sensors 206 can include a single sensor, one of each of the foregoing sensors, or any combination of the foregoing sensors.

Signal data indicative of a user's gestures can be communicated from the sensors 206 in the wearable device 200 to a mobile device or other computing device on or through which security access management is performed. The wearable device 200 can be held, worn, or otherwise coupled to the user as needed to accurately identify or generate the signal data by the sensors 206. The signal data, prior to communication from the wearable device 200, upon receipt by the mobile device, or at some other point, can be processed to accurately identify the gestures made by the user. For example, signal data communicated from accelerometers can undergo pre-processing to remove extraneous signal features, feature extraction to isolate signal features usable for identifying the gestures, and gesture recognition (e.g., using offline training based on labeled data) to determine the gestures as further described below.

The communication component 208 is a hardware component configured to communicate data (e.g., measurements, etc.) communicated from the sensors 206 to one or more external devices, such as a mobile device or a computing device, for example, as discussed above with respect to FIG. 1. In one implementation, the communication component 208 comprises an active communication interface, for example, a modem, transceiver, transmitter-receiver, or the like. In another implementation, the communication component 208 comprises a passive communication interface, for example, a quick response (QR) code, Bluetooth identifier, radio-frequency identification (RFID) tag, a near-field communication (NFC) tag, or the like. Implementations of the communication component 208 can include a single component, one of each of the foregoing components, or any combination of the foregoing components.

The output 210 of the wearable device 200 can include one or more input/output devices, such as a display. In one implementation, the display can be coupled to the CPU 202 via a bus. In another implementation, other output devices may be included in addition to or as an alternative to the display. When the output 210 is or includes a display, the display may be implemented in various ways, including by an LCD, CRT, LED, OLED, etc. In one implementation, the display can be a touch screen display configured to receive touch-based input, for example, in manipulating data output to the display.

FIG. 3 is a diagram of a mobile device 300, for example, for use in the security system of FIG. 1. In one implementation, the mobile device 300 comprises CPU 302, memory 304, bus 306, storage 308, input 310, and output 312. Like the wearable device 200 of FIG. 2, the mobile device 300 can include at least one processor such as CPU 302. Alternatively, the CPU 302 can be any other type of device, or multiple devices, capable of manipulating or processing information now-existing or hereafter developed. Although the examples herein can be practiced with a single processor as shown, advantages in speed and efficiency can be achieved using more than one processor.

As with the memory 204 of the wearable device 200 in FIG. 2, the memory 304 can comprise RAM or any other suitable type of storage device. The memory 304 can include executable instructions and data for immediate access by the CPU 302. The memory 304 can include one or more DRAM modules such as DDR SDRAM. Alternatively, the memory 304 can include another type of device, or multiple devices, capable of storing data for processing by the CPU 302 now-existing or hereafter developed. The CPU 302 can access and manipulate data in the memory 304 via the bus 306.

The mobile device 300 can optionally include storage 308 in the form of any suitable non-transitory computer readable medium, such as a hard disc drive, a memory device, a flash drive, or an optical drive. The storage 308, when present, can provide additional memory when high processing requirements exist. The storage 308 can include executable instructions along with other data. Examples of executable instructions may include, for example, an operating system and one or more application programs for loading in whole or in part into the memory 304 to be executed by CPU 302. The operating system may be, for example, Windows, Mac OS X, Linux, or another operating system suitable to the details of this disclosure. The application programs can be executable instructions for processing signal data communicated from the wearable device 200, for communicating the signal data to one or more other devices, or both.

The mobile device 300 can include one or more input devices 310, such as a keyboard, a numerical keypad, a mouse, a microphone, a touch screen, a sensor, or a gesture-sensitive input device. Through the input device 310, data can be input from the user or another device. The input device 310 can also be any other type of input device including an input device not requiring user intervention. For example, the input device 310 can be a communication component such as a wireless receiver operating according to any wireless protocol for receiving signals. The input device 310 can also output signals or data, indicative of the inputs, to the CPU 302 using the bus 306.

The mobile device 300 can also include one or more output devices 312. The output device 312 can be any device transmitting a visual, acoustic, or tactile signal to the user, such as a display, a touch screen, a speaker, an earphone, a light-emitting diode (LED) indicator, or a vibration motor. If the output device 312 is a display, for example, the display may be implemented in various ways, including by an LCD, CRT, LED, OLED, or any other output device capable of providing visible output to the user. In some cases, the output device 312 can also function as an input device 310, for example, when a touch screen display is configured to receive touch-based input. The output device 312 can alternatively or additionally be formed of a communication component (not shown) for transmitting signals such as a modem, transceiver, transmitter-receiver, or the like. In one implementation, the communication component can be a passive communication interface, for example, a quick response (QR) code, Bluetooth identifier, radio-frequency identification (RFID) tag, a near-field communication (NFC) tag, or the like.

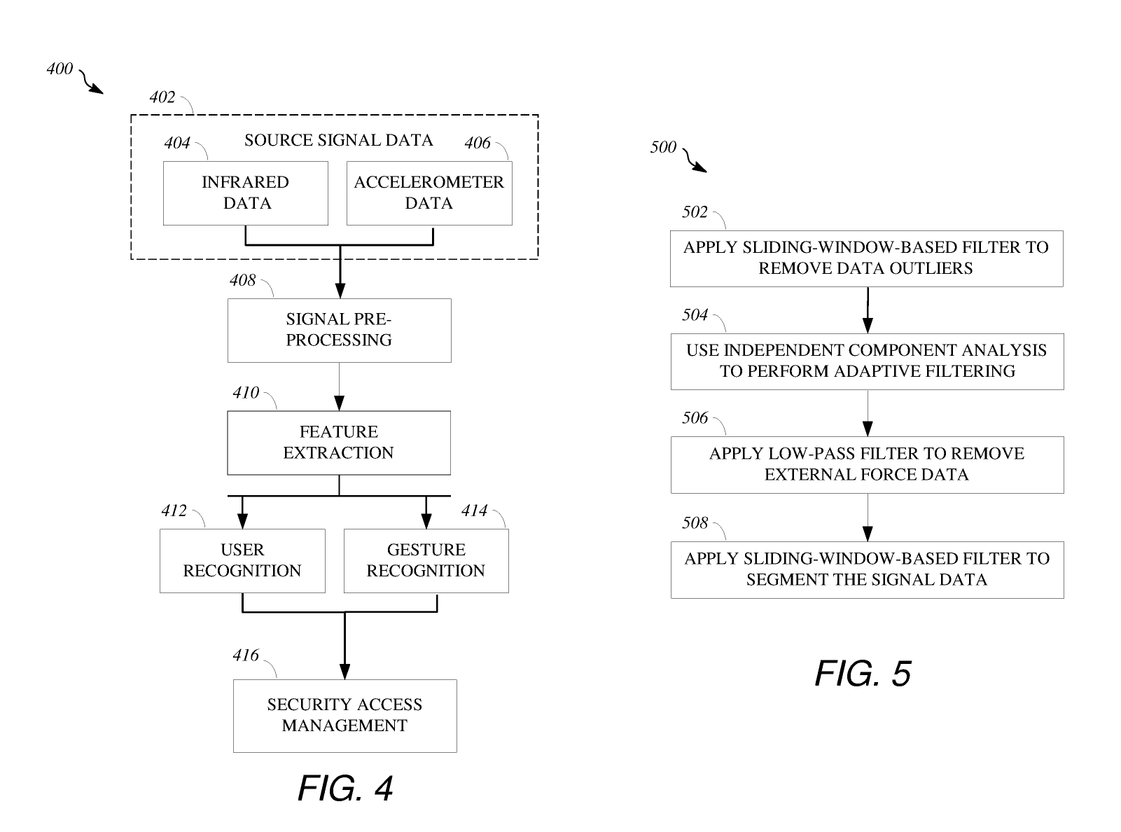

FIG. 4 is a logic diagram 400 showing an example of processing wearable device sensor data. Implementations of the logic diagram 400 can be performed entirely on the wearable device 200 on which the sensor data is generated, on the wearable device 200 and the mobile device 300, or on any other computing device (not shown) in communication with the wearable device 200 or the mobile device 300. For example, the signal processing aspects of logic diagram 400 can be performed by instructions executable on the mobile device 300. In one implementation, portions of the logic diagram 400 can be performed by instructions executable on the mobile device 300 and one or more other devices, such as security devices associated with the secured target 104 of FIG. 1.

In one example, source signal data 402 is generated by the sensors 206 of the wearable device 200. For example, source signal data 402 can comprise infrared data 404 and accelerometer data 406 generated from one or more infrared sensors and accelerometers, respectively, associated with the wearable device 200. The infrared data 404 can be used to detect whether the wearable device 200 is worn and the accelerometer data 406 can be used for recognition of predefined gestures performed by the user wearing the wearable device 200. Other sensors can be used to provide the source signal data 402 as well. For example, a circuit-based sensor can be configured to detect whether the wearable device 200 is clasped or buckled, a current-sensing sensor can be configured to detect whether current from the wearable device 200 is able to be grounded through the user's body, or a motion sensor can be configured to detect whether the wearable device 200 is static or on a surface having a fixed orientation.

The source signal data 402 can be processed by various operations, such as signal pre-processing 408 and feature extraction 410, in order to remove extraneous signal features, such as those unnecessary for determining whether the user is wearing the wearable device 200 or whether a gesture was made using the wearable device 200, from the source signal data 402. Signal pre-processing 408 is described further in respect to FIG. 5.

Feature extraction 410 can be performed on pre-processed signal data to isolate signal features by extracting time-domain features and spatial features. The time-domain features extractable from the pre-processed signal data include, for example, temporal mean features, feature variations within specified or unspecified time windows, local minimum temporal features, local maximum temporal features, temporal variances and medians, mean-crossing rates, and the like. The time-domain features can be identified, for example, based on a correlation between sensors associated with the wearable device 200.

The spatial features extractable from the pre-processed signal data include, for example, wavelet features, Fast Fourier transform features (e.g., peak positions), discrete cosine transform features, arithmetic cosine transform features, Hilbert-Huang transform features, spectrum sub-band energy features or ratios, and the like. The spatial features can also include spectrum entropy, wherein high entropy can be discerned based on inactivity (e.g., stationarity) indicative of a uniform data distribution and low entropy can be discerned based on activity (e.g., movement) indicative of a non-uniform data distribution.

User recognition 412 can be performed using the feature-extracted signal data to identify that the user is wearing the wearable device 200. The feature-extracted signal data useful for user recognition 412 can include, for example, infrared data 404, current data, or motion data. Gesture recognition 414 can be performed using the feature-extracted signal data to determine the actual gestures made using the wearable device 200, for example, using the feature-extracted signal data and offline training data to process the feature-extracted signal data based on labeled data.

Gesture recognition 414 can include identifying gesture probabilities by referencing a library comprising data associated with one or more secured targets. In one implementation, the gesture probabilities can indicate a probability that a corresponding gesture is signaled for access to a specific secured target. For example, the probability can be based on the frequency that the gesture needs to be made for association with the secured target, the likelihood of the gesture being made using the body part of the user to which the wearable device 200 is coupled, and so on. In one implementation, the offline training data comprises data indicative of activity combinations and their corresponding gesture probabilities (e.g., based on gestures per body part, past user data, etc.). In another implementation, bio-mechanical models indicative of body part gesture probabilities can be included within or used as a supplementary reference by the offline training data.

Gesture recognition 414 can also include comparing the pre-processed and feature-extracted signal data and the identified gesture probabilities. For example, where the pre-processed and feature-extracted signal data is determined to be similar or identical to gesture data represented within the offline training data, it can be determined that the pre-processed and feature-extracted signal data is indicative of a gesture corresponding to that gesture data. In one implementation, comparing the pre-processed and feature-extracted signal data and the identified gesture probabilities can be done by overlaying the respective data and quantizing the differences, wherein a lower number of differences can be indicative of a higher similarity between the data.

The output from user recognition 412 and gesture recognition 414 can be sent for security access management 416. For example, if the wearable device 200 is detected as worn by the user through user recognition 412, the wearable device 200 can send an indication to the user regarding readiness to receive gestures, such as by haptic vibration or a sequence of LED lights generated using the output 210. Once the user performs predefined gestures that are matched to a gesture template using gesture recognition 414, security access management 416 can encrypt predefined security information, for example, into security access signal data in a radio transmission protocol suitable to be sent to devices such as the mobile device 300. The wearable device 200 need not be proximate to the mobile device 300 to generate such security access signal data. The mobile device 300 can receive such protocol and decrypt it to serve as a password, security key, or payment confirmation, for example, when the secured target is an application.

FIG. 5 is a flow chart 500 showing an example of pre-processing signal data consistent with the signal pre-processing operation 408 of FIG. 4. Signal pre-processing can be done to remove unnecessary data (e.g., aspects of the communicated source signal data 402 not related or material to determining use of the wearable device 200 or a gesture indicated by the source signal data 402). In one implementation, performing signal pre-processing includes using filters, for example, sliding-window-based average or median filters, adaptive filters, low-pass filters, and the like, to remove the unnecessary data.

At operation 502 in the flow chart 500, a first filter is applied to the source signal data 402 to remove data outliers, which may, for example, represent portions of the communicated source signal data 402 not indicative of the device being worn or the actual gesture that was made. In one implementation, the first filter can be a sliding-window-based filter, such as a sliding-window-based average filter or a sliding-window-based median filter.

At operation 504 in the flow chart 500, adaptive filtering is performed with respect to the filtered signal data. In one implementation, adaptive filtering is performed using independent component analysis, for example, to distinguish between signal data features communicated from different sensors of the wearable device 200. In another implementation, performing adaptive filtering on the filtered signal data comprises determining a higher quality portion of the filtered signal data and processing the filtered signal data using the higher quality portion to denoise a lower quality portion.

At operation 506 in the flow chart 500, data indicative of external forces included within the filtered signal data can be removed, for example, using a low-pass filter. In one implementation, the external forces can be any force external to a gesture being made, for example, a gravitational force. Removal of external forces can be done to distinguish features of the filtered signal data indicative of user use or activity from those indicative of non-activity. For example, features indicative of non-activity can be removed from the filtered signal data to better focus on data that may be indicative of the gestures made.

At operation 508 in the flow chart 500, the filtered signal data is segmented to complete pre-processing. Segmentation can be done to better indicate or identify aspects of the filtered signal data comprising data indicative of the wearable device 200 being worn or of a gesture made by a user of the wearable device 200, for example, by separating the filtered signal data into or otherwise identifying it as comprising different groups of data indicative of different worn features and gesture features. In one implementation, segmentation can be performed by applying a sliding-window-based filter to the filtered signal data.

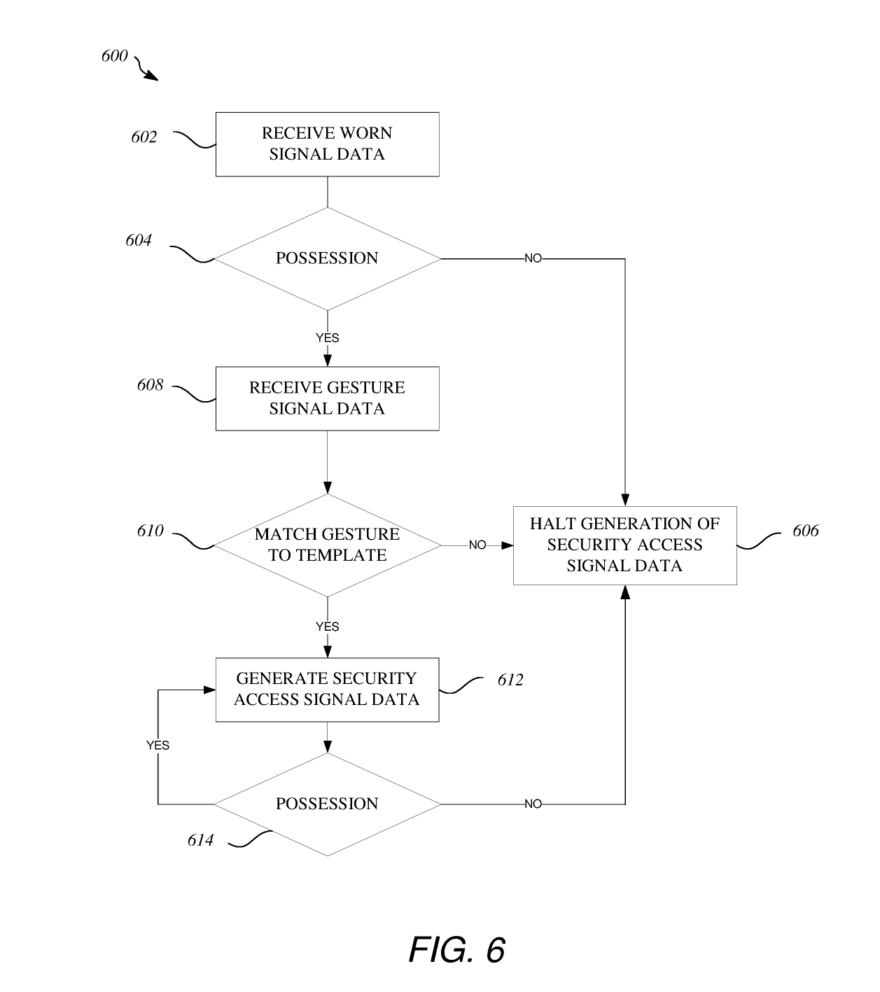

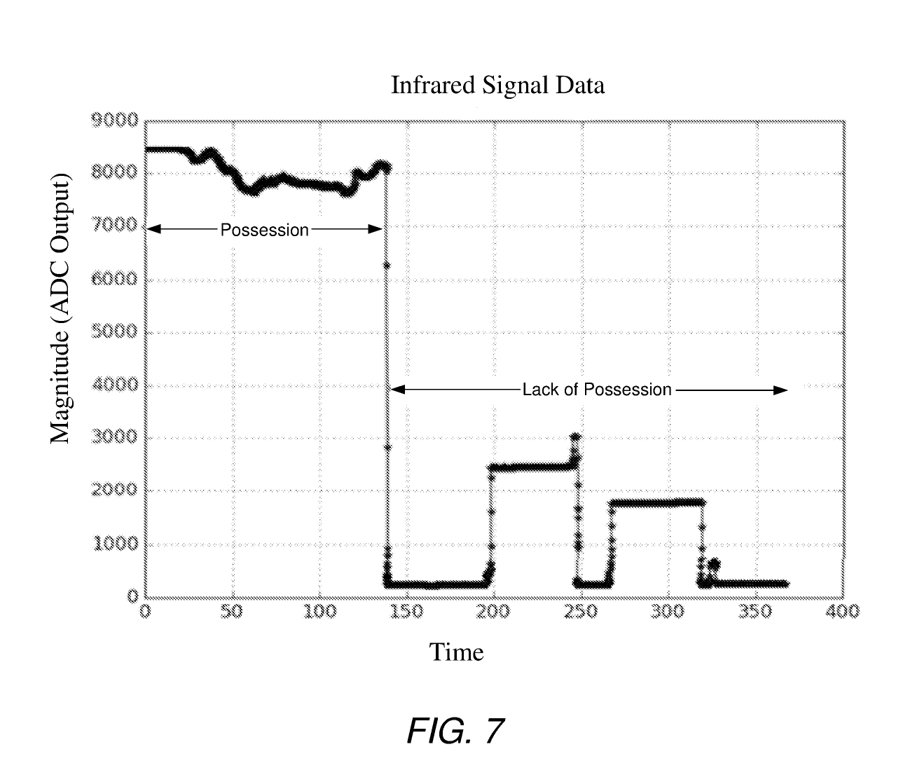

FIG. 6 is a flow chart 600 showing an example of a process for gesture-based access control of a secured target, for example, the secured target 104 of FIG. 1 or secured applications associated with the mobile device 300 of FIG. 3. At operation 602, worn signal data is received. In one example, worn signal data can be received from a wearable device such as the wearable device 200 of FIG. 2. The use of an infrared sensor associated with the wearable device 200 to capture worn signal data is described below in reference to FIG. 7. In another example, worn signal data can be received from a mobile device such as the mobile device 300 of FIG. 3. The worn signal data can indicate whether the user is holding the mobile device 300, proximate to the mobile device 300, or otherwise in possession of the mobile device 300 using, for example, touch-based sensors, image sensors, temperature sensors, etc. associated with the mobile device. Thus, operation 602 of receiving worn signal data can be accomplished using the wearable device 200 and/or the mobile device 300.

At decision tree 604, it is determined whether the worn signal data is indicative of possession of the wearable device 200 and/or the mobile device 300. Again, possession of the wearable device 200 can require that the user be wearing the wearable device 200 and possession of the mobile device 300 can require that the user is holding, proximate to, or otherwise in possession of the mobile device 300. If the worn signal data does not indicate possession, the process moves to operation 606, and generation of security access signal data is halted. In other words, if possession of the wearable device 200 and/or the mobile device 300 cannot be confirmed, no further operations in the process occur, and security access signal data is not generated.

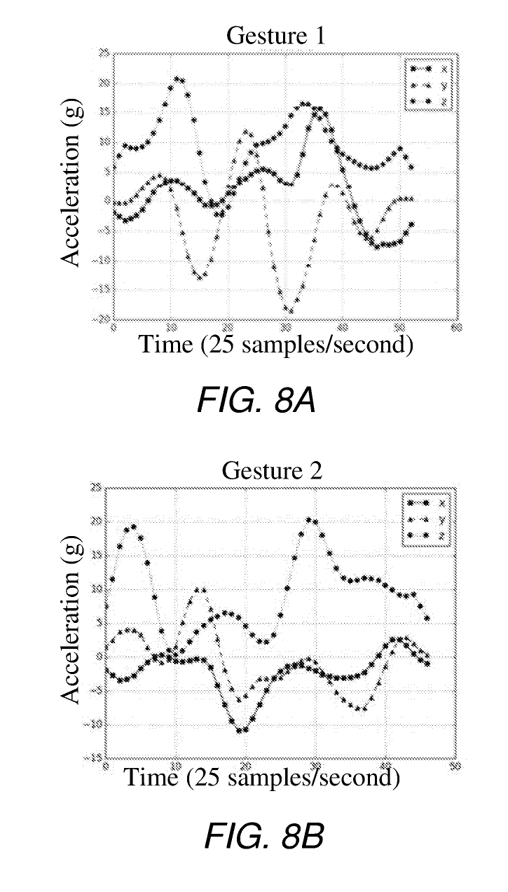

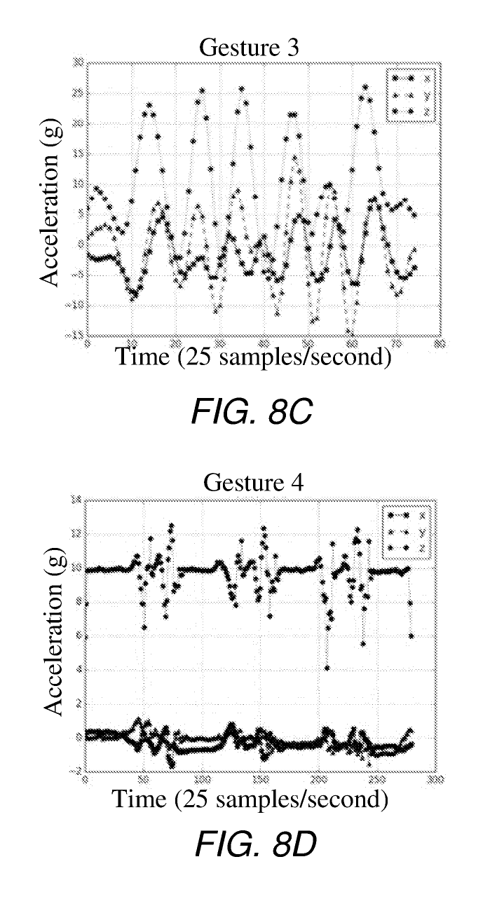

If the worn signal data does indicate possession, the process moves to operation 608 where gesture signal data indicative of at least one gesture performed by the user is received. In some examples, the wearable device 200 or the mobile device 300 can generate an indication for the user to perform the at least one gesture once possession is determined. The indication can be audible, include haptic vibration, flash a sequence of LED lights generated using the output 210 of the wearable device 200, or display a message to the user on output 312 of the mobile device 300. These are just several examples of possible indications inviting the user to perform one or more gestures. Further, a variety of different gestures can be performed by the user. A few examples of gesture signal data indicative of gestures are described in reference to FIGS. 8A-8D.

At decision block 610, the gesture signal data is compared to stored gesture templates to determine whether a match is present. Matching can include, for example, determining a threshold level of similarity between acceleration signal data and a gesture template. A gesture recognition classifier, such as a Dynamic Time Warping (DTW) algorithm, can be applied to determine whether received gesture signal data matches a gesture template to identify the gesture. As long as a gesture is repeated by a user in a similar manner as compared to when the gesture template was created and stored by the user, the gesture recognition classifier can identify the gesture represented in the gesture signal data. A normalized DTW distance can be computed between the gesture signal data and each gesture template stored by the user. A gesture match can be identified by selecting the gesture template having the minimum distance from the processed gesture signal data.

If the gesture does not match any stored gesture templates, the process moves to operation 606, and generation of security access signal data is halted. If the gesture does match at least one gesture template, the process moves to operation 612. In operation 612, security access signal data is generated based both on the worn signal data indicating possession of the wearable device 200 and/or the mobile device 300 and on the gesture performed by the user matching a gesture template. For example, security access signal data can include security access information being encrypted into a radio transmission protocol and transmitted by the wearable device 200, the mobile device 300, or both, such that nearby devices can receive such a protocol and decrypt it to serve as a password, security key, or payment confirmation.

By using a layered or tiered security system, where both possession of a mobile device and performance of a gesture are required, the user has the option of performing such a gesture in a private area in order to enable the mobile device, be it the wearable device 200, the mobile device 300, or both, in advance to serve as the password, security key, or payment confirmation whenever the user encounters the designated secured target associated with the performed gesture. Once a security access feature has been enabled, that is, once the mobile device is confirmed as in the user's possession and the gesture has been matched to a gesture template, the mobile device can provide an indication acknowledging that access to the secured target is possible. In the same vein, the layered or tiered security system can negate access to the secured target if possession of the mobile device is lost.

After the security access signal has been generated, the process moves to decision tree 614, and it is again determined whether worn signal data is indicative of possession of the wearable device 200 and/or the mobile device 300. If worn signal data continues to indicate that the user possesses the wearable device 200 and/or the mobile device 300, for example, if the user is wearing the wearable device 200 or holding the mobile device 300, the process returns to operation 612, and the security access signal continues to be generated, allowing the wearable device 200, the mobile device 300, or both to be ready to access a secured target.

If worn signal data instead indicates a lack of possession, for example, if the user is no longer wearing the wearable device 200 or is not proximate to the mobile device 300, the process returns to operation 606, and generation of the security access signal is halted. For example, and referring back to FIGS. 1A and 1B, the user can put on a wristband version of the wearable device 100 at home and perform a gesture associated with unlocking the secured target 104 of a door at work, thereby enabling either the wearable device 100, the mobile device 102, or the combination of the two to provide an unlock command for the secured target 104 in the form of a door. If the user proceeds to remove the wearable device 100 or loses the wearable device 100 on the way to the secured target 104, generation of the security access signal would be halted, and the user would be blocked from opening the secured target 104. After operation 606, the process ends.

FIG. 7 is a graphical illustration of infrared signal data captured by the wearable device 200. When the sensors 206 in the wearable device 200 include an infrared sensor, the analog output of that sensor can be converted to a digital output (ADC output) and compared to a threshold to determine whether the user is actually wearing the wearable device 200. As shown in FIG. 7, the ADC output, or magnitude, of the infrared signal data fluctuates between 7,000 and 9,000 when the user is actually wearing the wearable device 200. The magnitude of the infrared signal fluctuates between zero and 3,000 when the user is not wearing the wearable device 200. These ranges are representative of an example infrared sensor, other ranges or other sensors 206 can be used to determine whether the wearable device 200 is worn by the user.

FIGS. 8A-8D are graphical illustrations of acceleration signal data for user-designated gestures. Acceleration signal data can be captured, for example, when sensors 206 of the wearable device 200 or those of the mobile device 300 include one or more accelerometers. In FIG. 8A, acceleration values (in g) are shown for three axes, x, y, z when the user moves the wearable device 200 or the mobile device 300 in a motion path following the shape of the number eight. In. FIG. 8B, acceleration values are shown for the user moving the wearable device 200 or the mobile device 300 in a motion path following the shape of a square.

Acceleration signal data can also be captured, for example, using inputs 310 such as touch-sensitive or gesture-sensitive displays associated with the wearable device 200 or the mobile device 300. In FIG. 8C, acceleration values are shown for the user performing a touch-based or gesture-based input using a display of the mobile device 300 along a motion path following the user's personal signature. In FIG. 8D, acceleration values are shown for the user performing a sequence of taps and pauses on a surface of the wearable device 200 or an input 310 of the mobile device 300.

The examples in FIGS. 8A-8D represent user-designated gestures of differing complexity and discretion. The gestures in the examples in FIGS. 8A-8B, motions paths following a number and a shape, are simple in complexity but easily discernible by others. The gestures of FIGS. 8C-8D are more complex, but less obvious to others who may be present around the user. Different applications or secured targets can require different levels of gesture complexity. For example, removal of a lock screen on a mobile device may require only a simple gesture while authorizing a payment application may require a more complex gesture.

All of the gestures described in FIGS. 8A-8D can easily be performed my moving the wearable device 200 including an accelerometer as one of the sensors 206 along a motion path. Alternatively, the wearable device 200 or the mobile device 300 can include inputs 310 or sensors configured to receive touch-based inputs of the same types of gestures. Selection of the specific gesture to associate with a secured target can be based on a personal choice of the user and/or on the complexity level requirement for security of the application. Some users may even associate more than one gesture with a given secured target to increase security. Additionally, the wearable device 200 can be associated with multiple secured targets, each secured target accessed by a different gesture or group of gestures.

While the disclosure has been described in connection with certain embodiments and implementations, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for gesture-based access control of a secured target using a mobile device, comprising:
receiving, from a sensor of the mobile device, worn signal data indicative of possession of the mobile device by a user;
receiving, from the sensor of the mobile device, gesture signal data indicative of at least one gesture performed by the user; and
based on the worn signal data indicating possession of the mobile device and the at least one gesture matching a gesture template, generating security access signal data configured to provide access to the secured target.

2. The method of claim 1, wherein the mobile device is a wearable device and wherein possession of the mobile device comprises the wearable device being worn by the user.

3. The method of claim 2, wherein the sensor comprises an infrared sensor and an accelerometer.

4. The method of claim 1, further comprising:
after generating the security access signal data, receiving, from the sensor of the mobile device, worn signal data indicative of a lack of possession of the mobile device.

5. The method of claim 4, further comprising:
responsive to the worn signal data indicating a lack of possession of the mobile device, halting generation of the security access signal data.

6. The method of claim 1, further comprising:
responsive to receiving the worn signal data indicative of possession, generating an indication for the user to perform the at least one gesture.

7. The method of claim 6, wherein the indication is generated by the mobile device and includes an audible, visible, or tactile notification to the user.

8. The method of claim 1, further comprising:
responsive to receiving the worn signal data indicative of possession and the at least one gesture matching the gesture template, generating an indication for display to the user that a security access feature associated with the secured target is enabled.

9. The method of claim 1, further comprising:
performing, by the mobile device, pre-processing on the gesture signal data and feature extraction on the pre-processed gesture signal data; and
determining, by the mobile device, the at least one gesture based on the pre-processed and feature-extracted gesture signal data and offline training data.

10. A wearable device for gesture-based access control of a secured target, comprising:
a body configured to be coupled to a portion of a user;
a sensor comprising an infrared sensor and an accelerometer;
a communication component configured to communicate signal data generated by the sensor to a computing device; and
a memory and a processor configured to execute instructions stored in the memory to:
receive worn signal data from the infrared sensor indicative of the wearable device being worn by the user;
receive gesture signal data from the accelerometer indicative of at least one gesture performed by the user; and
based on the worn signal data indicating the wearable device is worn by the user and the at least one gesture matching a gesture template, generate security access signal data configured to provide access to the secured target.

11. The wearable device of claim 10, wherein the wearable device is one of a wristband, a ring, or a pendant.

12. The wearable device of claim 10, wherein the processor is further configured to:
after generating the security access signal data, receive, from the infrared sensor, worn signal data indicative of the wearable device no longer being worn by the user; and
responsive to the worn signal data indicating that the wearable device is no longer worn by the user, halt generation of the security access signal data.

13. The wearable device of claim 10, wherein the processor is further configured to:
responsive to receiving the worn signal data indicating the wearable device is worn by the user, generate an indication for the user to perform the at least one gesture, wherein the indication is generated by the wearable device and includes an audible, visible, or tactile notification to the user.

14. The wearable device of claim 10, wherein the processor is further configured to:
responsive to receiving the worn signal data indicating the wearable device is worn by the user and the at least one gesture matching the gesture template, generate an indication that a security access feature associated with the secured target is enabled, wherein the indication is generated by the wearable device and includes an audible, visible, or tactile notification to the user.

15. A system for gesture-based access control of a secured target, comprising:
a wearable device comprising a sensor and a communication component;
a mobile device in communication with the communication component, the mobile device comprising a memory and a processor configured to execute instructions stored in the memory to:
receive, from the sensor through the communication component, worn signal data indicative of the wearable device being worn by a user;
receive, from the sensor through the communication component, gesture signal data indicative of at least one gesture performed by the user; and
based on the worn signal data indicating the wearable device is worn by the user and the at least one gesture matching a gesture template, generate security access signal data configured to provide access to the secured target.

16. The system of claim 15, wherein the wearable device is one of a wristband, a ring, or a pendant.

17. The system of claim 15, wherein the sensor comprises an infrared sensor and an accelerometer.

18. The system of claim 15, wherein the processor is further configured to:
after generating the security access signal data, receive, from the sensor through the communication component, worn signal data indicative of the wearable device no longer being worn by the user; and
responsive to the worn signal data indicating that the wearable device is no longer worn by the user, halt generation of the security access signal data.

19. The system of claim 15, wherein the processor is further configured to:
responsive to receiving the worn signal data indicating the wearable device is worn by the user, generate an indication for the user to perform the at least one gesture, wherein the indication is generated by the wearable device or the mobile device and includes an audible, visible, or tactile notification to the user.

20. The system of claim 15, wherein the processor is further configured to:
responsive to receiving the worn signal data indicating the wearable device is worn by the user and the at least one gesture matching the gesture template, generate an indication that a security access feature associated with the secured target is enabled, wherein the indication is generated by the wearable device or the mobile device and includes an audible, visible, or tactile notification to the user.
